(19) United States
(12) Patent Application Publication
(10) Pub. No.: US 2017/0048533 A1
(43) Pub. Date: Feb. 16, 2017

(54) VIDEO TRANSCODING METHOD AND DEVICE

(71) Applicants: LE HOLDINGS (BEIJING) CO., LTD., Beijing (CN); LeCloud Computing Co., Ltd., Beijing (CN)

(72) Inventors: Yang Liu, Beijing (CN); Maosheng Bai, Beijing (CN); Wei Wei, Beijing (CN); Yangang Cai, Beijing (CN); Zhi Bian, Beijing (CN)

(21) Appl. No.: 15/245,039

(22) Filed: Aug. 23, 2016

Related U.S. Application Data
(63) Continuation of application No. PCT/CN2016/087023, filed on Jun. 24, 2016.

(30) Foreign Application Priority Data
Aug. 12, 2015 (CN) 201510493729.1

(51) Int. Cl. H04N 19/40; H04N 19/59

(52) U.S. Cl. CPC H04N 19/40; H04N 19/59

(57) ABSTRACT

The embodiment of the present disclosure discloses a video transcoding method and a video transcoding device, used for solving the problems in the prior art that a user cannot clearly watch video content during watching and the user experience is reduced because the content of the sampled screen video is vague. The method comprises the following steps: recognizing an original video, and determining whether the original video is a screen video; and transcoding the original video according to a resolution ratio of the original video if the original video is the screen video. According to the embodiment of the present disclosure, the screen video does not need to be sampled, and the content of the transcoded video is not vague, so that the user can clearly watch the video content during watching.

### CROSS-REFERENCE TO RELATED APPLICATIONS

The present disclosure is a continuation of International Application No. PCT/CN2016/087023 filed on Jun. 24, 2016, which is based upon and claims priority to Chinese Patent Application No. 201510493729.1, entitled “VIDEO TRANSCODING METHOD AND DEVICE”, filed on Aug. 12, 2015, the entire contents of all of which are incorporated herein by reference.

### FIELD OF TECHNOLOGY

The embodiment of the present disclosure relates to the technical field of media and in particular relates to a video transcoding method and device.

### BACKGROUND

With rapid development of multimedia technology, users can watch a variety of videos through various player terminals. Taking a video website as an example, lots of video resources are provided for users to watch in the video website, the users can select recommended videos in the video website to play and can search videos needing to be watched on the video website. The searched video can be played on the video website after the search result is obtained, and various requirements of the users are met. Many screen videos can be provided on the video website at present, and the screen videos refer to videos formed by recording operation conditions of computer screens through software. For example, with rapid growth of online education, many educational screen videos are produced and spread on an internet. Contents of the screen videos include PPT explanation, application software teaching and the like, users need to acquire knowledge from the videos while watching the screen videos and need to seriously watch the video contents while listening to the explanations; and therefore, the contents of the screen videos are required to be clear.

In the prior art, in order to further improve the user experience and meet user requirements to a greater degree, the video website also can perform video transcoding aiming at the original video so as to convert the original video into multiple formats (grades) suitable for different network bandwidths, such as compatibility, standard definition, high-definition, super-definition and other formats, the various formats correspond to different resolution ratios and bitrates, and the users can select corresponding formats to play according to the network bandwidth conditions while watching the videos. In the traditional video transcoding process, for a video suitable for a large bandwidth format, the video resolution ratio and bitrate obtained by transcoding are high; and for a video suitable for a small bandwidth format, the video resolution ratio and bitrate obtained by transcoding are low; and therefore, the original video needs to be sampled so as to achieve different resolution ratios in the transcoding process.

However, for the screen video, if the previous transcoding mode is adopted, the content of the sampled screen video is vague; and therefore, the users cannot clearly watch the video content while watching.

### SUMMARY

The embodiment of the present disclosure discloses a video transcoding method and a video transcoding device, used for solving the problems in the prior art that a user cannot clearly watch video content during watching and the user experience is reduced because the content of the sampled screen video is vague.

The embodiment of the present disclosure provides a video transcoding method, including:

recognizing an original video, and determining whether the original video is a screen video;

and transcoding the original video according to a resolution ratio of the original video if the original video is the screen video.

The embodiment of the present disclosure provides a computing device for video transcoding, including at least one processor; and a memory communicably connected with the at least one processor for storing instructions executable by the at least one processor, wherein execution of the instructions by the at least one processor causes the at least one processor to:

recognize an original video, and determining whether the original video is a screen video;

transcode the original video according to a resolution ratio of the original video when the video recognition module recognizes that the original video is the screen video.

The embodiment of the present disclosure provides computing device, including one or more processors; a storage; and one or more modules, wherein the one or more modules are stored in the storage and configured to be executed by the one or more processors, and the one or more modules are configured to be used for recognizing an original video, and determining whether the original video is a screen video; and transcoding the original video according to a resolution ratio of the original video if the original video is the screen video.

The embodiment of the present disclosure provides a computer readable storage medium on which a program used for executing the method in the embodiment of the present disclosure is recorded.

According to the video transcoding method and video transcoding device provided by the embodiment of the present disclosure, when the original video is transcoded, the original video is not directly transcoded according to a resolution ratio corresponding to a transcoded target format, but recognized and determined whether a screen video, if the original video is determined to be the screen video, the original video is transcoded according to the resolution ratio of the original video, namely transcoding is performed in a form of not changing the resolution ratio of the original video. Therefore, the screen video does not need to be sampled, and the content of the transcoded video is not vague, so that the user can clearly watch the video content while watching.

### BRIEF DESCRIPTION OF FIGURES

To clearly describe the technical schemes in the embodiments of the present disclosure or in the prior art, figures needing to be used in the description of the embodiments or the prior art are briefly introduced as follows, obviously, figures described below are some embodiments of the present disclosure, and for common technicians of the field, other figures can be also obtained according to figures under the condition that no creative work is made.

FIG. 1 shows the flow chart of steps of the video transcoding method in one embodiment of the present disclosure.

FIG. 2 shows the flow chart of steps of the video transcoding method in another embodiment of the present disclosure.

FIG. 3 shows the structure diagram of the video transcoding device in one embodiment of the present disclosure.

FIG. 4 shows the structure diagram of the video transcoding device in another embodiment of the present disclosure.

FIG. 5 shows the block diagram of computing device used for executing the method according to the present disclosure.

FIG. 6 shows a storage unit used for keeping or carrying the program codes for realizing the method according to the present disclosure.

### DESCRIPTION OF THE EMBODIMENTS

To make the purposes, technical schemes and advantages of the embodiments of the present disclosure clearer, the technical schemes in the embodiments of the present disclosure are clearly and completely described with the following figures in the embodiments of the present disclosure, the described embodiments are not all but a part of the embodiments of the present disclosure. Based on the embodiments of the present disclosure, other embodiments obtained by common technicians of the field under the condition that no creative work is made all belong to the protection scope of the present disclosure.

### Embodiment I

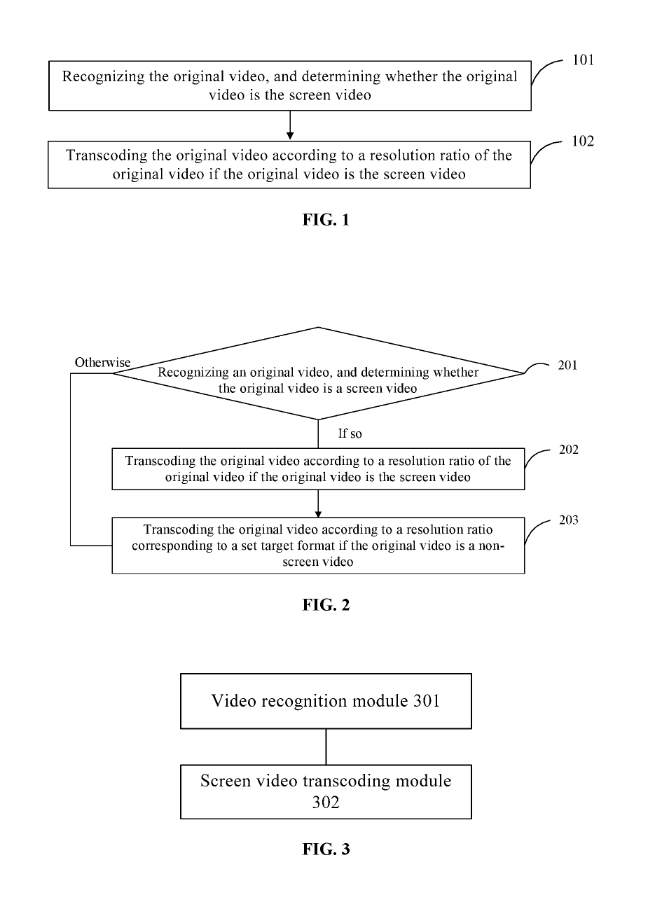

FIG. 1 shows the flow chart of steps of the video transcoding method in one embodiment of the present disclosure.

The video transcoding method in the embodiment can include the steps as follows.

Step 101, recognizing an original video, and determining whether the original video is a screen video.

The embodiment of the present disclosure gives description by taking video transcoding of the video website as an example. Resources of a plurality of original videos can be saved in a server of the video website, the server can perform video transcoding on the original video so as to acquire a plurality of videos suitable for different bandwidths formats, and the users can select videos of corresponding formats to play in a client of the video website according to the network bandwidth state.

In the embodiment of the present disclosure, a specific video transcoding mode is adopted aiming at a screen video class original video and, therefore, the original video is recognized before transcoding so as to determine whether the original video is a screen video, if the original video is the screen video, video transcoding is performed in a specific mode in a step 102; and if the original video is a non-screen video, transcoding is performed without using a set mode in the step 102 (the specific process is described in the following embodiments), wherein the screen video refers to a video formed by recording the operating condition of a computer screen through software.

Step 102, transcoding the original video according to a resolution ratio of the original video if the original video is a screen video.

If the original video is recognized to be the screen video in the step 101, the video is not transcoded according to the resolution ratio of a video of a target format in the transcoding process, while the original video is transcoded according to the resolution ratio of the original video so as to acquire a plurality of videos suitable for different bandwidths formats. The video transcoding refers to an operation of converting a compressed and coded video code stream into another video code stream so as to adapt to different network bandwidths, different terminal processing abilities and different user requirements, transcoding is essentially a successively decoding and coding process, and after a target code stream is acquired, technical personnel in the field performs related processing on the specific transcoding process of the original video. Detailed description is unnecessary in the embodiment of the present disclosure.

When transcoded in the embodiment of the present disclosure, the original video is not directly transcoded according to a resolution ratio corresponding to a transcoded target format, but recognized and determined whether a screen video, if the original video is determined to be the screen video, the original video is transcoded according to the resolution ratio of the original video, namely transcoding is performed in a form of not changing the resolution ratio of the original video. Therefore, the screen video does not need to be sampled, and the content of the transcoded video is not vague, so that the user can clearly watch the video content while watching, and the user experience is improved.

### Embodiment II

FIG. 2 shows the flow chart of steps of the video transcoding method in another embodiment of the present disclosure.

The video transcoding method in the embodiment can include the steps as follows.

Step 201, recognizing an original video, and determining whether the original video is a screen video.

In the embodiment of the present disclosure, before transcoding, the original video is recognized so as to determine the type of the original video, namely whether the original video is a screen video is determined, different transcoding modes are selected for processing according to different recognition results, if the original video is determined to be the screen video, the original video is transcoded in a manner of executing a step 202; and if the original video is determined to be the non-screen video, the original video is transcoded in a manner of executing a step 203.

Preferably, in the embodiment of the present disclosure, before the original video is recognized, a video recognition model is generated by pre-training, and when the original video is recognized, the video is recognized by utilizing the video recognition model. How to train to generate the video recognition model is specifically introduced in the followings.

Preferably, the video recognition model can be generated by adopting a SVM (Support Vector Machine) manner in the embodiment of the present disclosure, SVM is a supervised machine learning method and is generally used for performing mode recognition and classification, regression analysis and the like, and the step of generating the model by using the SVM includes sample preparation, characteristic extraction and model training; and therefore, the process of training to generate the video recognition model in the embodiment can include the steps as follows.

Step A1, acquiring a sample video, and extracting sample characteristic parameters of the sample video.

One part of videos can be acquired from video resources of the whole network to serve as sample videos, one sample video refers to a video file, and the number of screen videos and non-screen videos in the sample videos can be the same or different. For example, 5000 sample videos can be acquired from the video resources of the whole network, wherein the number of positive samples (the screen videos) is 2500, the number of negative samples (the non-screen videos) is 2500, and the sample videos are random in time length and content.

The analysis of the characteristics of the screen videos and the non-screen videos shows that the distinct difference of the screen videos and the non-screen videos is that the inter-frame information change of the screen videos is relatively small. Therefore, the characteristics are taken as training characteristics in the present disclosure, furthermore, by considering each frame video image of the sample videos, when the sample videos adopt YUV420 (wherein Y represents Luminance or Luma), namely a gray-scale values, and U and V represent Chrominance or Chroma and other formats, the dimensionality of the characteristic parameter is m=width*height*2, wherein the width and height respectively represent the width and height of a frame video image, however, the data volume is large, and the processing procedure is complex; and therefore, the characteristic parameter is subjected to dimension reduction processing in the embodiment of the present disclosure o as to measure the inter-frame information change by virtue of inter-frame luminance change.

Therefore, the step A1 of extracting the sample characteristic parameters of the sample video may include steps as follows.

A11, aiming at each sample video, extracting the luminance component, namely a component Y, of each frame video image in the current sample video respectively.

The component Y represents the luminance component of a frame video image and is a two-dimensional matrix, the width and height of the matrix are consistent with width and height of a corresponding frame video image, namely a pixel in the video image corresponds to an element in the two-dimensional matrix. For example, if the width and height pixel value of the video image is 640*480, the component Y which corresponds to the frame video image is a two-dimensional matrix including 640 rows*480 columns of elements.

A12, aiming at each sample video, calculating the difference of luminance components of adjacent video images of every two frames in the total video images of the current sample videos, and calculating the mean of the total differences.

The mean is calculated through the following formula 1:

$$mean = \frac{1}{n - 1} {\sum }_{i = 1}^{n - 1} ( {Y}_{i + 1} - {Y}_{i} ) . \qquad FORMULA 1$$

In the formula 1, n represents the total frame number of the total video images of the current sample videos, Yi represents the luminance component of an i^{th} frame video image of the current sample videos, and Yi+1 represents the luminance component of an (i+1)th frame video image of the current sample videos.

A13, aiming at each sample video, calculating standard deviation sd of the luminance components of the total video images of the current sample videos according to the mean which corresponds to the current sample videos.

The mean standard deviation sd is calculated through the following formula 2:

$$sd = \sqrt{\frac{1}{n - 2} {\sum }_{i = 1}^{n - 1} {( ( {Y}_{i + 1} - {Y}_{i} ) - mean )}^{2}} . \qquad FORMULA 2$$

Aiming at each sample video, calculating the mean which corresponds to the current sample videos and the standard deviation, taking the mean and the standard deviation as sample characteristic parameters which corresponds to the current sample videos, wherein the dimensionality of the characteristic is 2. Compared with the dimensionality m, the computation complexity is greatly reduced. According to the process, the sample characteristic parameter of each sample video is acquired (each sample video corresponds to two sample characteristic parameters, namely the mean and the standard deviation), the minimum parameter value min(D) and the maximum parameter value max(D) in the sample characteristic parameters of the total sample videos can be acquired, namely the minimum value and maximum value in the means of the total sample videos can be acquired, and the minimum value and maximum value in the standard deviations of the total sample vides are acquired.

What needs to explain is that the sample characteristic parameters of the sample videos in the embodiment of the present disclosure are not limited to the mean and the standard deviation, and taking other applicable parameters as the sample characteristic parameters is feasible. For example, aiming at each sample video, the difference of the luminance components of adjacent video images of every two frames in the total video images of the current sample videos is calculated, and the sum of the total differences is calculated, wherein the sum serves as the sample characteristic parameter which corresponds to the current sample video, and the like.

Step A2, training according to the sample characteristic parameter of each sample video, and generating a video recognition model.

Preferably, the SVM used in the embodiment of the present disclosure can be a nonlinear C-support vector classification machine (C-SVC). Therefore, the step A2 can include steps as follows.

A21, aiming at each sample video, scaling the sample characteristic parameter of the current sample video respectively.

In the training process, the sample characteristic parameters mean and sd of each sample video acquired in the step A1 can be respectively scaled, namely normalized, so that the sample characteristic parameters are scaled to [L, U], and due to the scaling, the condition that data sets are unbalanced because some sample characteristic parameters are extremely wide in range and another sample characteristic parameters are extremely narrow in range can be avoided, and a complex calculation process while calculating a kernel function also can be avoided. In the embodiment of the present disclosure, the processes of scaling the two sample characteristic parameters such as the mean and the standard deviation are the same, and the scaling process aiming at each sample characteristic parameter may include step as follows.

A211, acquiring the set minimum scale value and maximum scale value, and the minimum parameter value and maximum parameter value in the sample characteristic parameters of a plurality of sample videos.

During scaling, the characteristic parameters can be scaled to [−1, 1] or [0, 1] and the like, if scaled to [−1, 1], the minimum scale value L is equal to −1 and the maximum scale value U is equal to 1; and if scaled to [0, 1], the minimum scale value L is equal to 0 and the maximum scale value U is equal to 1. After the minimum parameter value min(D) and the maximum parameter value max(D) in the sample characteristic parameters of the plurality of sample videos are acquired, the max(D) and min(D) can be saved in a file for later use of recognizing the original video.

A212, scaling the sample characteristic parameter of the current sample video according to the minimum scale value and maximum scale value and the minimum parameter value and maximum parameter value.

Scaling is performed according to the following formula 3:

$${D}^{′} = \frac{D - min ( D )}{max ( D ) - min ( D )} \times ( U - L ) + L . \qquad FORMULA 3$$

In the formula 3, L is the minimum scale value, U is the maximum scale value, min (D) is the minimum parameter value, max (D) is the maximum parameter value, D is the characteristic parameter of the current sample video, and D′ is the scaled sample characteristic parameter.

A22, training according to the scaled sample characteristic parameter, and generating a video recognition model.

Firstly, calculating to acquire related parameters a* and b* of the video recognition model, wherein a* represents slope of a classification straight line, and b* represents offset of the classification straight line.

$${min}_{w , b} \frac{1}{2} {‖ w ‖}^{2} + C {\sum }_{i = 1}^{1} {ɛ}_{i} \\ subject to \text{:} \\ {y}_{i} ( ( w \times {x}_{i} + b ) ) \geq 1 - {ɛ}_{i} , i = 1 , … , 1 \\ {ɛ}_{i} \geq 0 , i = 1 , … , 1 \\ C > 0. \qquad FORMULA 4$$

The parameter W in the formula 4 is calculated according to a formula 5:

$$w = {\sum }_{i = 1}^{l} {y}_{i} {α}_{i} {x}_{i} . \qquad FORMULA 5$$

A dual problem of the formula 4 is shown as a formula 6:

$${min}_{α} \frac{1}{2} {\sum }_{i = 1}^{1} {\sum }_{j = 1}^{1} {y}_{i} {y}_{j} {α}_{i} {α}_{j} K ( {x}_{i} , {x}_{j} ) - {\sum }_{j = 1}^{1} {α}_{j} \\ s . t . \text{:} \\ {\sum }_{i = 1}^{1} {y}_{i} {α}_{i} = 0 \\ 0 \leq {α}_{i} \leq C , i = 1 , … , 1. \qquad FORMULA 6$$

K(xᵢ, xⱼ) represents a kernel function, and the kernel function in the embodiment of the present disclosure can use a RBF (Radial Basis Function) and is shown as a formula 7:

$$K ( {x}_{i} * {x}_{j} ) = exp ( - \frac{{‖ {x}_{i} - {x}_{j} ‖}^{2}}{2 {σ}^{2}} ) . \qquad FORMULA 7$$

wherein, C represents a penalty parameter, εᵢ represents a slack variable which corresponds to the i^{th} sample video, xᵢ represents the scaled sample characteristic parameter which corresponds to the i^{th} sample video, yᵢ represents the type of the i^{th} sample video (namely the sample video is a screen video or a non-screen video, for example, 1 represents the screen video, −1 represents the non-screen video, and the like), xⱼ represents the scaled sample characteristic parameter which corresponds to the j^{th} sample video, yⱼ represents the type of the j^{th} sample video, σ represents an adjustable parameter of the kernel function, l represents the total number of the sample videos, and the symbol “∥ ∥” represents a norm.

The optimal solution of the formula 6 can be calculated according to the formulas 4-7, as shown in a formula 8:

α*=(α₁*, . . . , αₗ*)^{T} FORMULA 8.

The b* can be calculated according to a*, as shown in a formula 9:

$${b}^{*} = {y}_{j} - {\sum }_{i = 1}^{l} {y}_{i} {α}_{i}^{*} K ( {x}_{i} , {x}_{j} ) \qquad FORMULA 9$$

In the formula 9, the numerical value of j is obtained by selecting a positive component 0<αⱼ*<C from a*.

In the embodiment of the present disclosure, the initial value of the previous penalty parameter C can be set to be 0.1, the initial value of the parameter σ in the RBF kernel function is set to be 1e-5, the related parameters a* and b* of the video recognition model can be calculated according to the formulas 4-9, the technical personnel in the field perform related processing on the specific process of calculating the parameters a* and b* according to practical experience, and detailed description is avoided in the embodiment of the present disclosure.

Secondly, the video recognition model shown as a formula 10 can be obtained according to the related parameters a* and b*:

$$f ( x ) = sgn ( {\sum }_{i = 1}^{1} {α}_{i}^{*} {y}_{i} K ( x , {x}_{i} ) + {b}^{*} ) . \qquad FORMULA 10$$

Preferably, in order to improve the generalization ability of the training model, the optimal value of the parameters σ and C can be found by selecting a K-folder cross-validation method aiming at the video recognition model in the embodiment of the present disclosure. For example, if the folder k is selected as 5, the range of the penalty parameter C is set to be [0.1, 500], and the range of the parameter σ0 of the kernel function is set to be [1e-5, 4]. In the validation process, the step length of each of σ and C is selected as 5, the optimal parameter acquired after K-folder cross-validation is C=312.5, σ is equal to 3.90625, the sample video is trained based on the optimal parameter after the optimal parameter is acquired, the related parameters a* and b* of the video recognition model are acquired, and the video recognition model in the formula 7 is obtained and is saved in the file.

After the video recognition model is generated through the mode, the original video can be recognized by adopting the video recognition model.

Preferably, the step 201 can include the sub-steps as follows.

Sub-step a1, acquiring the original characteristic parameter which corresponds to the original video.

Preferably, the sub-step a1 can include the sub-steps as follows.

Sub-step a11, extracting a luminance component of each frame video image in the original video respectively.

Sub-step a12, calculating the difference of luminance components of adjacent video images of every two frames in the total video images of the original video, and calculating the mean of the total differences. The mean can be calculated by the formula 1 in the sub-step a12.

Sub-step a13, calculating standard deviation of the luminance components of the total video images according to the mean. The standard deviation can be calculated by the formula 2 in the sub-step a13.

The mean and the standard deviation which correspond to the original video are calculated, namely the mean and the standard deviation can serve as the original characteristic parameters which correspond to the original video.

The specific process of the sub-step a1 is basically similar to the specific process of extracting the sample characteristic parameter aiming at each sample video, by specifically referring to the related description. Detailed description is avoided in the embodiment of the present disclosure.

Sub-step a2, scaling the original characteristic parameter to scale the original characteristic parameter into a set range.

Preferably, the sub-step a2 can include the sub-steps as follows:

Sub-step a21, acquiring the set minimum scale value and maximum scale value, and the minimum parameter value and maximum parameter value in the sample characteristic parameters of a plurality of sample videos;

Sub-step a22, scaling the original characteristic parameter according to the minimum scale value and maximum scale value and the minimum parameter value and maximum parameter value.

The scaled original characteristic parameter can be calculated by the formula 3 in the sub-step a22, namely the original characteristic parameter is scaled according to the following formula:

$${D}^{′} = \frac{D - min ( D )}{max ( D ) - min ( D )} * ( U - L ) + L$$

wherein, L is the minimum scale value, U is the maximum scale value, min (D) is the minimum parameter value, max (D) is the maximum parameter value, D is the original characteristic parameter of the current sample video, and D′ is the scaled original characteristic parameter.

The sub-step a1 is basically similar to the step A21, the related can refer to related description in the reference step A21, and detailed description is avoided in the embodiment of the present disclosure.

Sub-step a3, taking the scaled original characteristic parameter as input of a video recognition model obtained by pre-training, and acquiring an output result of the video recognition model, wherein the output result is used for indicating whether the original video is the screen video.

The scaled original characteristic parameter serves as the input of the video recognition model shown as the formula 10, namely x in the formula 10 represents the scaled sample characteristic parameter which corresponds to the original video, Sgn function return in the formula 10 represents an integer of digital symbol, the output result of the formula 10 can indicate whether the original video is the screen video, if the output result is 1, the original video is the screen video, and if the output result is −1, the original video is the non-screen video and the like.

For example, if the original video is a video A, firstly acquiring the original characteristic parameters m (mean) and n (standard deviation) which correspond to the video A, respectively scaling the m and n, scaling the m to obtain m′, and scaling the n to obtain n′; taking a matrix [m′, n′] as x in the formula 10 in the subsequent process of recognizing the video A by utilizing the video recognition model shown as the formula 10, calculating to obtain an output result f(x), if the f(x) is 1, the video A is a screen video, and if the f(x) is −1, the video A is a non-screen video.

Step 202, transcoding the original video according to a resolution ratio of the original video if the original video is a screen video.

If the original video is recognized to be the screen video in the step 201, in order to avoid the condition that the transcoded screen video is vague because the screen video is sampled in the video transcoding process, the original video is transcoded according to the resolution ratio of the original video aiming at the original video of the type in the embodiment of the present disclosure.

Preferably, the step 202 of transcoding the original video according to the resolution ratio of the original video can include keeping the resolution ratio of the original video invariable aiming at each set target format, and transcoding the original video into a video in a target format. An original video can be transcoded into multiple videos in different target formats, as shown in the table 1, the original video can be transcoded into videos of seven grades (namely target formats) such as compatibility, high speed, standard definition, high-definition, super-definition, 720P and 1080P, the resolution rate and frame rate of the transcoded video of each grade are source following (source following refers to the same as the original video), the Bitrate of the video of each grade is calculated by multiplying the Bitrate of the original video and a corresponding coefficient (specific coefficients are shown as the table 1), and the Bitrate of the video corresponds to the maximum Bitrate and minimum Bitrate. If the calculated Bitrate of the video of a certain grade exceeds a range between the maximum Bitrate and minimum Bitrate, a certain Bitrate between the maximum Bitrate and minimum Bitrate is selected as the Bitrate of the video of the grade. According to the transcoding manner, the original video does not need to be sampled in the transcoding process; and therefore, the definition of the sampled video content (such as characters and the like) is not reduced.

TABLE 1

| | Resolution | | Bitrate (Bitrate is a bitrate |
|---|---|---|---|
| Grade | ratio | Frame rate | of the original video) |
| Compatible | Source | Source | Input: Bitrate * 0.1 |
| | following | following | Minimum: 50 kb |
| | | | Maximum: 130 kb |
| High speed | Source | Source | Input: Bitrate * 0.2 |
| | following | following | Minimum: 50 kb |
| | | | Maximum: 130 kb |
| Standard | Source | Source | Input: Bitrate * 0.4 |
| definition, | following | following | Minimum: 50 kb |
| | | | Maximum: 180 kb |
| High-definition | Source | Source | Input: Bitrate * 0.6 |
| | following | following | Minimum: 100 kb |
| | | | Maximum: 250 kb |
| Super-definition | Source | Source | Input: Bitrate * 0.8 |
| | following | following | Minimum: 150 kb |
| | | | Maximum: 350 kb |
| 720P | Source | Source | Input: Bitrate * 0.9 |
| | following | following | Minimum: 200 kb |
| | | | Maximum: 500 kb |
| 1080P | Source | Source | Input: Bitrate * 1.0 |
| | following | following | Minimum: 250 kb |
| | | | Maximum: 600 kb |

Step 203, transcoding the original video according to a resolution ratio corresponding to a set target format if the original video is a non-screen video.

If the original video recognized in the step 201 is a non-screen video, considering that the requirement on definition of characters and other contents when the non-screen video is watched by a user is lower than that of the screen video, if the non-screen video is transcoded in the manner of the step 202, great bandwidth waste is caused. Therefore, the original video aiming at the non-screen video type does not adopt the screen video transcoding method in the embodiment of the present disclosure, and the original video is transcoded according to the resolution ratio corresponding to the set target format.

Preferably, the process of transcoding the original video according to the resolution ratio corresponding to the set target format in the step 203 can include modifying the resolution ratio of the original video into a resolution ratio corresponding to the target format aiming at each set target format so as to transcode the original video into a video of the target format. Aiming at each target format, the corresponding resolution ratio can be respectively set; the original video is sampled in the transcoding process to achieve the resolution ratio corresponding to the target format. For example, if the resolution ratio corresponding to the target format is smaller than the resolution ratio of the original video, the original video is subjected to the following sampling process so as to reduce the resolution ratio; and if the resolution ratio corresponding to the target format is larger than the resolution ratio of the original video, the original video is subjected to the previous sampling process so as to improve the resolution ratio. For the specific transcoding process, the technical personnel in the field can perform related processing according to practical experience, and detailed description is avoided in the embodiment of the present disclosure.

The original video is automatically recognized in the embodiment of the present disclosure, the screen video type original video adopts a video transcoding manner of keeping the original resolution ratio invariable, the non-screen video type original video adopts a video transcoding manner of changing the resolution ratio; and therefore, for the screen video, the transcoded video also can keep the definition of the characters and other contents in case of small bandwidth, the user experience is improved, and waste of bandwidth can be avoided for the non-screen video.

For each previous embodiment of the method, in order to simply describe, the method is described as a series of action combinations; however, the technical personnel in the field should know that the present disclosure is not limited by the described action sequence because certain steps can be performed by adopting other sequences or simultaneously according to the present disclosure. Moreover, the technical personnel in the field also should know that the described embodiments in the specification belong to preferred embodiments, and the involved actions and modules are not always necessary for the present disclosure.

### Embodiment III

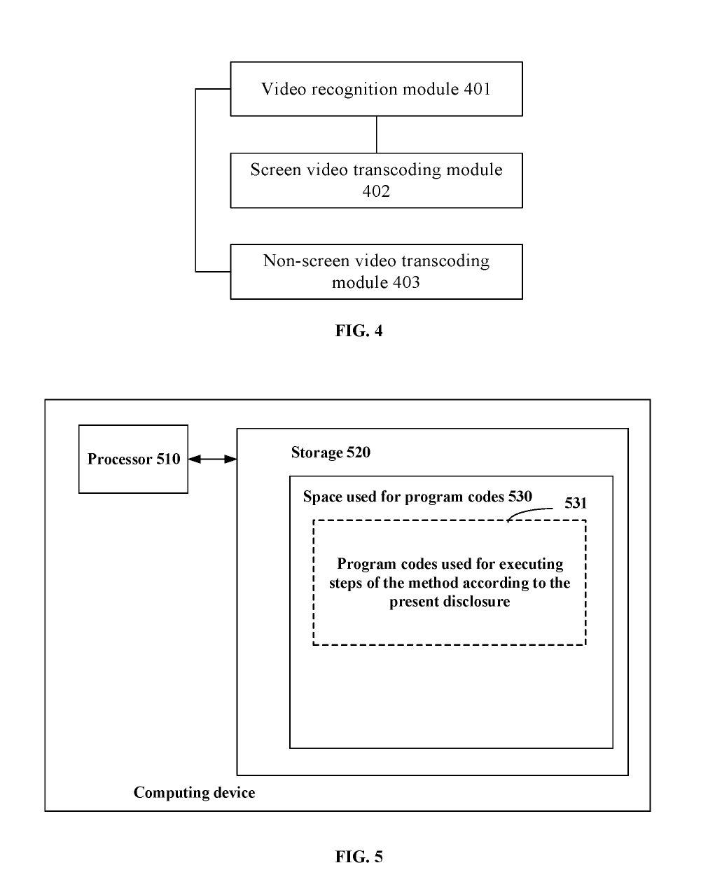

FIG. 3 shows the structure diagram of the video transcoding device in one embodiment of the present disclosure.

The video transcoding device in the embodiment can include the following modules:

a video recognition module 301, used for recognizing an original video, and determining whether the original video is a screen video;

a screen video transcoding module 302, used for transcoding the original video according to a resolution ratio of the original video when the video recognition module recognizes that the original video is the screen video.

When transcoded in the embodiment of the present disclosure, the original video is not directly transcoded according to a resolution ratio corresponding to a transcoded target format, but recognized and determined whether a screen video, if the original video is determined to be the screen video, the original video is transcoded according to the resolution ratio of the original video, namely transcoding is performed in a form of not changing the resolution ratio of the original video. Therefore, the screen video does not need to be sampled, and the content of the transcoded video is not vague, so that the user can clearly watch the video content while watching, and the user experience is improved.

### Embodiment IV

FIG. 4 shows the structure diagram of the video transcoding device in another embodiment of the present disclosure;

The video transcoding device in the embodiment can include the following modules:

a video recognition module 401, used for recognizing an original video, and determining whether the original video is a screen video;

a screen video transcoding module 402, used for transcoding the original video according to a resolution ratio of the original video when the video recognition module recognizes that the original video is the screen video.

Preferably, the video transcoding device also can include a non-screen video transcoding module 403, used for transcoding the original video according to a resolution ratio corresponding to a set target format when the video recognition module recognizes that the original video is the non-screen video.

Preferably, the screen video transcoding module 402 is specifically used for keeping the resolution ratio of the original video invariable and transcoding the original video into a video of the target format aiming at each set target format.

Preferably, the video recognition module 401 also can include the following sub-modules: an acquiring sub-module, used for acquiring the original characteristic parameter which corresponds to the original video; a scaling sub-module, used for scaling the original characteristic parameter so as to scale the original characteristic parameter into a set range; and a recognizing sub-module, used for taking the scaled original characteristic parameter as input of a video recognition model obtained by pre-training, and acquiring an output result of the video recognition model, wherein the output result is used for indicating whether the original video is the screen video.

Preferably, the acquiring sub-module can include the following sub-units: a luminance extracting sub-unit, used for respectively extracting a luminance component of each frame video image in the original video; and a parameter calculating sub-unit, used for calculating the difference of luminance components of adjacent video images of every two frames in the total video images, and calculating the mean of the total differences; calculating standard deviation of the luminance components of the total video images according to the mean; and taking the mean and the standard deviation as the original characteristic parameter which corresponds to the original video.

Preferably, the scaling sub-module can include the following sub-units: a parameter acquiring sub-unit, used for acquiring the set minimum scale value and maximum scale value, and acquiring the minimum parameter value and maximum parameter value in sample characteristic parameters of a plurality of preset sample videos; and a parameter processing sub-unit, used for scaling the original characteristic parameter according to the minimum scale value and maximum scale value and the minimum parameter value and maximum parameter value.

Preferably, the parameter processing sub-unit is specifically used for scaling the original characteristic parameter according to the following formula:

$${D}^{′} = \frac{D - min ( D )}{max ( D ) - min ( D )} \times ( U - L ) + L$$

wherein, L is the minimum scale value, U is the maximum scale value, min (D) is the minimum parameter value, max (D) is the maximum parameter value, D is the original characteristic parameter, and D′ is the scaled original characteristic parameter.

The original video is automatically recognized in the embodiment of the present disclosure, the screen video type original video adopts a video transcoding manner of keeping the original resolution ratio invariable, the non-screen video type original video adopts a video transcoding manner of changing the resolution ratio; and therefore, for the screen video, the transcoded video also can keep the definition of the characters and other contents in case of small bandwidth, the user experience is improved, and waste of bandwidth can be avoided for the non-screen video.

Because the embodiments of the device are basically similar to the embodiments of the method, the description is relatively simple, and the related can refer to partial description of the embodiments of the method.

The embodiments of the device described above are only schematic, wherein units serving as separate parts to describe can be (or not) physically separated, and parts serving as units to display can be (or not) physical units, namely the parts can be positioned in the same place or can be distributed onto multiple network units. Partial or total modules can be selected to achieve the aims of the scheme in the embodiments according to actual needs. The ordinary technical personnel in the field can understand and implement under the condition that the creative labor is not contributed.

Each embodiment of the device in the present disclosure can be realized by hardware, or by software operating on one or more processors, or by a combination of the hardware and software. The technical personnel in the field should understand that some or total functions of some or total parts in communication processing equipment according to the embodiment of the present disclosure can be realized in practice by using a microprocessor or a digital signal processor (DSP). The present disclosure also can realize equipment or device programs (such as computer programs and computer program products) used for executing one part or total of the described method. The program for realizing the present disclosure can be stored on a computer readable medium or can include one or multiple signal forms. The signals can be downloaded from an internet website or provided on a carrier signal or in any other form.

For example, the device in the present disclosure can be applied to a server; the server can traditionally include a processor and a computer program product or a computer readable medium in a storage form. The storage can be electronic storages such as a flash memory, an electrically-erasable programmable read-only memory (EEPROM), an EPROM, a hard disk or ROM. The storage is equipped with a storage space used for executing program codes in any method step of the previous method. For example, the storage space used for program codes can include each program code, which is respectively used for realizing each step in the previous method. The program codes can be read out of or written into one or more computer program products from the one or more computer program products. The computer program products include program code carriers such as hard disks, compact disks (CD), storage cards or floppy disks. The computer program products are generally portable or fixed storage units. The storage units can be equipped with storage sections, storage spaces and the like with similar arrangements to storages in the server. The program codes can be compressed in an appropriate form. Generally, the storage units include computer readable codes, namely codes read by the processors. When the server operates the codes, the server executes each step in the previous described method.

The ordinary technical personnel in the field can understand that total or partial steps for realizing the embodiment of the method can be realized by hardware related to program instructions, the previous program can be stored in a computer readable storage medium, when the program is executed, the steps including the embodiment of the method are executed; while the previous storage medium includes: ROM, RAM, disks or compact discs and other media capable of storing the program codes.

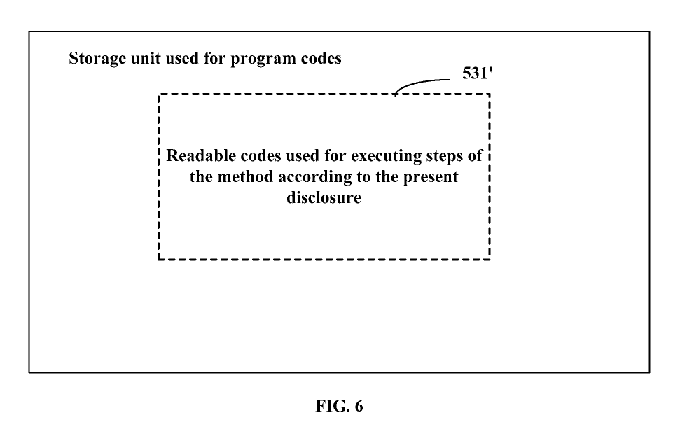

FIG. 5 shows the computing device capable of realizing the video transcoding method according to the present disclosure. The computing device (such as the server and the like) traditionally includes a processor 510 and a module (program) product in a storage 520 form or a readable medium. The storage 520 can be electronic storages such as a flash memory, an electrically-erasable programmable read-only memory (EEPROM), an EPROM or ROM. The storage 520 is equipped with a storage space 530 used for executing program codes 531 in any method step of the method. For example, the storage space 530 for program codes can include each program code 531 which is respectively used for realizing each step in the previous method. The program codes can be read out of or written into one or more computer program products from the one or more computer program products. The program products include program code carriers such as storage cards. The program products are generally portable or fixed storage units shown as FIG. 6. The storage units can be equipped with storage sections, storage spaces and the like with similar arrangements to the storage 520 in the computing device in FIG. 5. The program codes can be compressed in an appropriate form. Generally, the storage units include computer readable codes 631′, namely codes read by the processors such as 510. When a processor of the computing device operates the codes, the processor of the computing device executes each step in the previous described method.

The final description is that the embodiments are only used for describing the technical scheme of the present disclosure but not for limiting. Although the present disclosure is specifically described with reference to the embodiments, common technicians of the field shall understand that the technical scheme recorded by each of the embodiments can be modified, or one part of technical characteristics can be equivalently replaced; and the modification or replacement does not enable the essence of the corresponding technical scheme to get out of the spirit and scope of the technical scheme in each embodiment of the present disclosure.

What is claimed is:

1. A video transcoding method, comprising:
recognizing an original video, and determining whether the original video is a screen video; and
transcoding the original video according to a resolution ratio of the original video if the original video is the screen video.

2. The method according to the claim 1, wherein said transcoding the original video according to the resolution ratio of the original video comprises:
keeping the resolution ratio of the original video invariable aiming at each set target format, and transcoding the original video into a video of a target format.

3. The method according to the claim 1, wherein said recognizing the original video and determining whether the original video is the screen video comprises:
acquiring an original characteristic parameter which corresponds to the original video;
scaling the original characteristic parameter to scale the original characteristic parameter into a set range; and
taking the scaled original characteristic parameter as input of a video recognition model obtained by pre-training, and acquiring an output result of the video recognition model, wherein the output result is used for indicating whether the original video is the screen video.

4. The method according to the claim 3, wherein said acquiring the original characteristic parameter which corresponds to the original video comprises:
extracting a luminance component of each frame video image in the original video respectively;
calculating difference of luminance components of adjacent video images of every two frames in total video images, and calculating mean of the total differences;
calculating standard deviation of the luminance components of the total video images according to the mean; and
taking the mean and the standard deviation as the original characteristic parameter which corresponds to the original video.

5. The method according to the claim 3, wherein said scaling the original characteristic parameter comprises:
acquiring a set minimum scale value and a maximum scale value, and acquiring a minimum parameter value and a maximum parameter value in sample characteristic parameters of a plurality of preset sample videos; and
scaling the original characteristic parameter according to the minimum scale value and the maximum scale value and the minimum parameter value and the maximum parameter value.

6. The method according to the claim 5, wherein said scaling the original characteristic parameter according to the minimum scale value and the maximum scale value and the minimum parameter value and the maximum parameter value comprises:
scaling the original characteristic parameter according to a formula as follows:
$${D}^{′} = \frac{D - min ( D )}{max ( D ) - min ( D )} \times ( U - L ) + L$$
wherein L is the minimum scale value, U is the maximum scale value, min (D) is the minimum parameter value, max (D) is the maximum parameter value, D is the original characteristic parameter, and D′ is the scaled original characteristic parameter.

7. A computing device for video transcoding, comprising:
at least one processor; and
a memory communicably connected with the at least one processor for storing instructions executable by the at least one processor, wherein execution of the instructions by the at least one processor causes the at least one processor to:
recognize an original video, and determining whether the original video is a screen video;
transcode the original video according to a resolution ratio of the original video when the video recognition module recognizes that the original video is the screen video.

8. The computing device according to the claim 7, wherein said transcode the original video according to a resolution ratio of the original video when the video recognition module recognizes that the original video is the screen video comprises:
keep the resolution ratio of the original video invariable aiming at each set target format, and transcode the original video into a video of a target format.

9. The computing device according to the claim 7, wherein said recognize an original video, and determining whether the original video is a screen video comprises:
acquire an original characteristic parameter which corresponds to the original video;
scale the original characteristic parameter to scale the original characteristic parameter into a set range;
take the scaled original characteristic parameter as input of a video recognition model obtained by pre-training, and acquire an output result of the video recognition model, wherein the output result is used for indicating whether the original video is the screen video.

10. The computing device according to the claim 9, wherein said acquire an original characteristic parameter which corresponds to the original video comprises:
extract a luminance component of each frame video image in the original video respectively;
calculate difference of luminance components of adjacent video images of every two frames in total video images, and calculate mean of the total differences; calculate standard deviation of the luminance components of the total video images according to the mean; and take the mean and the standard deviation as the original characteristic parameter which corresponds to the original video.

11. The computing device according to the claim 9, wherein said scale the original characteristic parameter to scale the original characteristic parameter into a set range comprises:
acquire a set minimum scale value and a maximum scale value, and acquire a minimum parameter value and a maximum parameter value in sample characteristic parameters of a plurality of preset sample videos;
scale the original characteristic parameter according to the minimum scale value and the maximum scale value and the minimum parameter value and the maximum parameter value.

12. The computing device according to the claim 11, wherein said scale the original characteristic parameter according to the minimum scale value and the maximum scale value and the minimum parameter value and the maximum parameter value comprises: scale the original characteristic parameter according to a formula as follows:
$${D}^{′} = \frac{D - min ( D )}{max ( D ) - min ( D )} \times ( U - L ) + L$$
wherein L is the minimum scale value, U is the maximum scale value, min (D) is the minimum parameter value, max (D) is the maximum parameter value, D is the original characteristic parameter, and D′ is the scaled original characteristic parameter.

13. A non-transitory computer readable storage medium storing executable instructions that, when executed by a computing device, cause the electronic device to:
recognize an original video, and determining whether the original video is a screen video; and
transcode the original video according to a resolution ratio of the original video if the original video is the screen video.
